(19) United States
(12) Patent Application Publication
(10) Pub. No.: US 2015/0126696 A1
(43) Pub. Date: May 7, 2015

(54) POLYMERIZATION USING LATENT INITIATORS

(71) Applicant: EVONIK INDUSTRIES AG, Essen (DE)

(72) Inventors: Friedrich Georg Schmidt, Haltern am See (DE); Michael Buchmeiser, Remshalden (DE); Stefan Naumann, Heilbronn (DE)

(73) Assignee: EVONIK INDUSTRIES AG, Essen (DE)

(21) Appl. No.: 14/394,603

(22) PCT Filed: May 28, 2013
(86) PCT No.: PCT/EP2013/060916

§ 371 Date: Oct. 15, 2014

(30) Foreign Application Priority Data
Jun. 25, 2012 (DE) 10 2012 210 774.6

(51) Int. Cl. C08F 120/18

(52) U.S. Cl. CPC C08F 120/18
USPC 526/204

(57) ABSTRACT

The present invention relates to a novel, rapid initiation mechanism for polymerising (meth)acrylates using latent initiators based on N-heterocyclic carbene compounds which can be thermally activated, such as, in particular, N-heterocyclic carbene-CO₂ compounds, carbene-CS₂ compounds or carbene-metal compounds (NHC). Using the new initiation mechanism, molecular weights of 10 000 to over 500 000 g/mol and a narrow polydispersity can be achieved for polymerisation of MMA. The polymerisations can be carried out both without solvent and in solution.

### SCOPE OF THE INVENTION

The present invention relates to a novel, rapid initiation mechanism for polymerising (meth)acrylates using latent initiators based on N-heterocyclic carbene compounds which can be thermally activated such as, in particular, N-heterocyclic carbene-CO₂ compounds, carbene-CS₂ compounds or carbene-metal compounds (NHC). Using the new initiation mechanism, molecular weights of 10 000 to over 500 000 g/mol and a narrow polydispersity can be achieved for polymerisation of MMA. The polymerisations can be carried out both without solvent and in solution.

### PRIOR ART

A series of polymerisation methods for polymerising (meth)acrylates is known. Free radical polymerisation especially is of crucial industrial significance. The latter is used for polymerisation in bulk, solution, emulsion or suspension in many syntheses of poly(meth)acrylates for various applications. These include moulding compositions, Plexiglas, film-forming binders, additives or components in adhesives or sealants, to name but a few. The disadvantage of free-radical polymerisation however is that the polymer architecture cannot be influenced, that only very non-specific functionalisation is possible, and that the polymers form with wide molecular weight distributions.

High molecular weight and/or narrow distribution poly(meth)acrylates in contrast are available via an anionic polymerisation. Disadvantages of this polymerisation method in contrast are the high demands on the process, for example with respect to exclusion of moisture or to temperature, and the impossibility of introducing functional groups on the polymer chain. The same applies to the group transfer polymerisation of methacrylates, which to date is only of very minor significance.

In addition to the anionic methods, modern methods of controlled free-radical polymerisation are also suitable as living or controlled polymerisation methods. Both the molecular weight and the molecular weight distribution are adjustable. Living polymerisation further allows the controlled construction of polymer architectures such as, for example, random copolymers or else block copolymer structures.

An example is RAFT polymerisation (reversible addition fragmentation chain transfer polymerisation). The mechanism of the RAFT polymerisation is described in detail in EP 0 910 587. Disadvantages of the RAFT polymerisation are especially the limited synthetic possibilities for short-chain poly(meth)acrylates or of hybrid systems, and the sulphur groups remaining in the polymer.

The NMP method (nitroxide mediated polymerisation) in contrast has only very limited usability for the synthesis of poly(meth)acrylates. This method has major disadvantages with respect to various functional groups and the control of the molecular weight.

The ATRP method (atom transfer radical polymerisation) was developed in the 1990s primarily by Prof. Matyjaszewski (Matyjaszewski et al., J. Am. Chem. Soc., 1995, 117, p. 5614; WO 97/18247; Science, 1996, 272, p. 866). ATRP provides narrow distribution polymers in the molar mass range of Mₙ=10 000-120 000 g/mol. A distinct disadvantage is the use of transition metal catalysts, especially copper catalysts, which can be removed from the product only with considerable effort or only incompletely. Furthermore, acid groups interfere in the polymerisation, so that such functionalities are not achievable via ATRP directly.

A method for initiating (meth)acrylate polymerisation is disclosed in WO 2011/085856, in which the initiation is effected by the combination of, firstly, isocyanates or carbodiimides and, secondly, an organic base. This type of initiation is suitable to achieve high molecular weights, but it is overall comparatively slow.

N-Heterocyclic carbenes (NHC) have long been known as catalysts for silyl initiators in a Group Transfer Polymerization (GTP) (cf. Raynaud et al., Angew. Chem. Int. Ed., 2008, 47, p. 5390, and Scholten et al., Macromolecules, 2008, 41, p. 7399). Similarly, N-heterocyclic carbenes are known as catalysts in a step-growth polymerisation of terephthalaldehyde (cf. Pionaud et al., Macromolecules, 2009, 42, p. 4932). Zhang et al. (Angew. Chem. Int. Ed., 2010, 49, p. 10158) discloses NHC also as a Lewis base in combination with Lewis acids, such as for example NHC.Al(C₆F₅)₃ or NHC.BF₃. This combination is suitable as initiator for MMA. In Zhang et al. (Angew. Chem., 2012, 124, p. 2515) 1,3-di-tert-butylimidazolin-2-ylidene is disclosed also as a stand-alone initiator for the polymerisation of MMA or of furfuryl methacrylate. In the latter case, however, it was discovered that other NHCs have no initiating effect for MMA but only for cyclic monomers such as α-methylene-γ-butyrolactone (MBL) or γ-methyl-α-methylene-γ-butyrolactone (MMBL). Moreover, the carbenes used here are highly reactive per se, such that, firstly, handling is thereby difficult and, secondly, the polymerisation is rapidly initiated and relatively difficult to control.

### Object

The object of the present invention, against the background of the prior art discussed above, was to make available novel, latent initiators for polymerising (meth)acrylates that can firstly be initiated in a controlled manner and at the same time is feasible for producing latent 1K systems rapidly, simply and without particularly large energy expenditure.

In addition, it was an object of the present invention to make available a compound as latent initiator which is stable in the presence of monomers at temperatures of up to 25° C. for at least 8 h, i.e. to cause at most a 5% monomer conversion, and equally, following activation, to cause at least 90% conversion of the monomers to polymers.

Furthermore, the compounds used as latent initiators should themselves be stable on storage and both easy and safe to handle.

Further objects not specifically mentioned may be evident from the description, the examples and the claims, even without being explicitly stated at this point.

### Solution

The objects are achieved by a novel method for initiating a polymerisation of a vinyl monomer. In this method, the monomer mixture or monomer solution is treated with a protected N-heterocyclic carbene and the polymerisation is initiated by raising the temperature to an initiation temperature which is at least 40° C., preferably at least 50° C. The polymerisation is particularly preferably initiated at a temperature between 50° C. and 100° C.

This method is suitable for polymerising vinyl monomers such as acrylates, methacrylates, styrene or monomers derived from styrene. Mixtures of these monomers can also be polymerised using the method according to the invention.

In particular, the protected N-heterocyclic carbene is a compound having one of the two formulae (I) or (II)

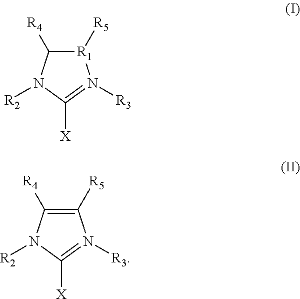

Here R₁ is a CH₂, C₂H₄, C₃H₆ or a corresponding substituted residue. R₂ and R₃ may be identical or different from one another. Preferably R₂ and R₃ are cyclic, branched or linear, optionally heteroatom-containing alkyl residues having 1 to 20 carbon atoms or substituted or non-substituted aromatic residues. R₄ and R₅ may be identical or different from one another. Preferably R₄ and R₅ are hydrogen or cyclic, branched or linear, optionally heteroatom-containing alkyl residues having 1 to 20 carbon atoms or substituted or non-substituted aromatic residues. X is CO₂, CS₂, Zn, Bi, Sn or Mg. Carbenes with one of these X groups are stable on storage and easy and safe to use. Preferably the latter are carboxylates (CO₂ protecting group) or dithionates (CS₂ protecting group), since the polymerisation can be effected with these compounds without the presence of metals.

Examples of the N-heterocyclic basic structure of the initiators used according to the invention are particularly imidazole, imidazoline, tetrahydropyrimidine and diazepine.

Alternatively the protected N-heterocyclic carbene can be a metal-free compound having one of the two formulae (III) or (IV)

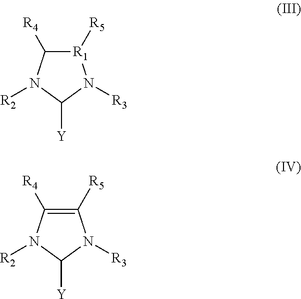

Here, R₁ is again a CH₂, C₂H₄, C₃H₆ or a corresponding substituted residue. R₂ and R₃ once again may be identical or different from one another. Also in these cases, the latter are preferably cyclic, branched or linear, optionally heteroatom-containing alkyl residues having 1 to 20 carbon atoms or substituted or non-substituted aromatic residues. R₄ and R₅ may be identical or different from one another. Preferably R₄ and R₅ are hydrogen or cyclic, branched or linear, optionally heteroatom-containing alkyl residues having 1 to 20 carbon atoms or substituted or non-substituted aromatic residues. The protecting group Y in contrast can be a CF₃, C₆F₄, C₆F₅, CCl₃ or OR₄ residue, where R₄ is an alkyl residue having 1 to 10 carbon atoms.

Some CO₂-protected N-heterocyclic carbenes are identified in the following, but this list should not be understood as limiting in any way. The protecting group especially is also replaceable by any of the other protecting groups listed. Examples of N-heterocyclic carbenes of formula (I) having a six-membered ring—i.e. R₁ is a (CH₂)₂ group—are 1,3-dimethyltetrahydropyrimidinium-2-carboxylate (1), 1,3-diisopropyltetrahydropyrimidinium-2-carboxylate (2), 1,3-bis(2,4,6-trimethylphenyl)tetrahydropyrimidinium-2-carboxylate (3), 1,3-bis(2,6-diisopropylphenyl)tetrahydropyrimidinium-2-carboxylate (4), 1,3-biscyclohexyltetrahydropyrimidinium-2-carboxylate (12) and 1,3-bis(4-heptyl)tetrahydropyrimidinium-2-carboxylate (13):

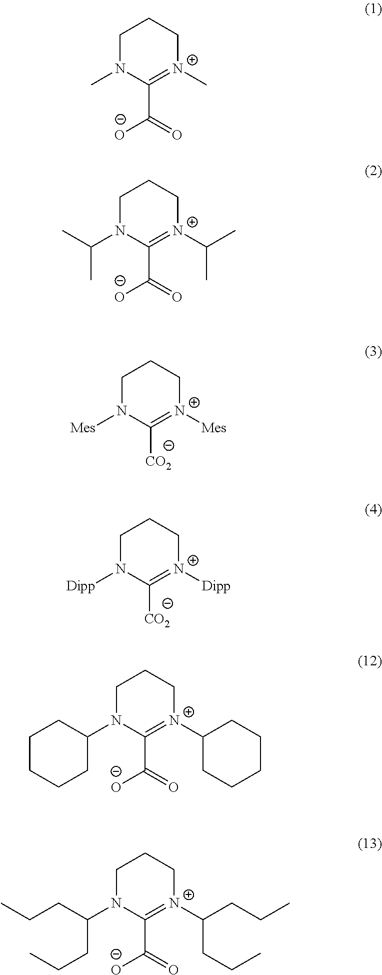

Here Mes is a 2,4,6-trimethylphenyl group and Dipp is a 2,6-diisopropylphenyl group.

Examples of formula (I) having a 7-membered ring, i.e. R₁ is a (CH₂)₃ group, are 1,3-bis(2,4,6-trimethylphenyl)tetrahydro-[1,3]-diazepinium-2-carboxylate (10) and 1,3-bis(2,6-diisopropylphenyl)tetrahydro-[1,3]-diazepinium-2-carboxylate (11):

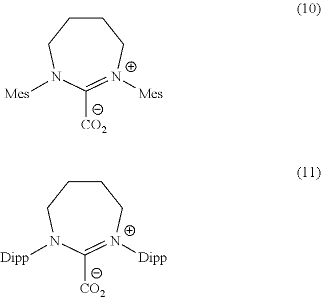

Examples of compounds of formula (II) are 1,3-diisopropylimidazolium-2-carboxylate (5), 1,3-di-tert-butylimidazolium-2-carboxylate (6), 1,3-dicyclohexylimidazolium-2-carboxylate (7), 1,3-bis(2,4,6-trimethylphenyl)imidazolium-2-carboxylate (8) and 1,3-adamantylimidazolium-2-carboxylate (9):

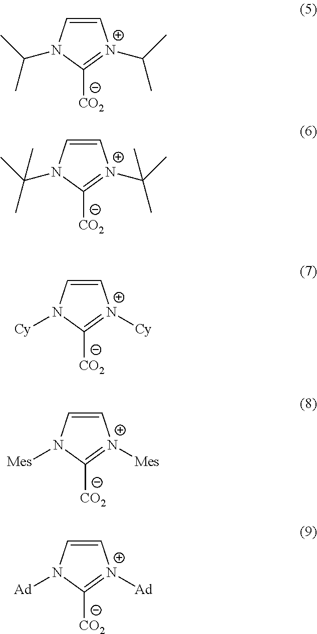

Here Cy is a cyclohexyl group and A_{d} is an adamantyl group.

An example of initiators of formula (I) with R₁ equal to CH₂ is 1,3-di-tert-butylimidazolinium-2-carboxylate (14):

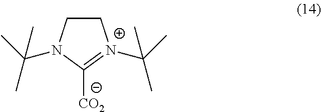

The preparation of these compounds is generally known from the literature. In particular, the cyclisation of amidines, which are readily available from amines and orthoesters, enables a simple route to various ring sizes.

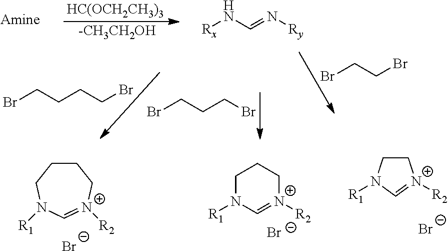

The deprotonation is preferably then carried out with a strong, sterically-hindered base such as, for example, potassium hexamethyldisilazide (KHMDS) in a solvent such as, for example, THF. The solvent is removed and the residue is made into a slurry with ether, for example. After filtration, CO₂ or another protecting group such as SnCl₂, for example, is added. A further subsequent filtration in for example, diethyl ether and drying under reduced pressure allows the synthesis of clean target compounds such that often no further recrystallisation is necessary. Together with the facile formation of amidines and their cyclisation with dihalides, an attractive synthetic route with a minimal number of steps is provided, in which no chromatography or other purification is necessary. These two reactions can also be carried out, for example, in air. Only the formation of the free carbene by reaction with the strong base has to be carried out in the absence of air. The synthesis may be found in, for example, Iglesias et al., Organometallics 2008, 27, 3279-3289. The synthesis of the corresponding CS₂ complexes can be found in Delaude, Eur. J. Inorg. Chem. 2009, 1681-1699 or in Delaude et al., Eur. J. Inorg. Chem. 2009, 1882-1891.

Surprisingly, we have found that the polymerisation can occur very rapidly at comparatively low temperatures of e.g. 80° C., depending on the protected N-heterocyclic carbene selected. Thus, a 50% monomer conversion is possible at 80° C. even at t₅₀<50 min. Equally, the polymerisation solutions or else a pure monomer mixture comprising the N-heterocyclic carbene can be combined such that these mixtures do not give rise to polymerisation at room temperature for several hours. A major advantage of the present invention is therefore the latency of the polymerisation.

This relationship affords major advantages in industrial processes. Thus, reaction mixtures can be prepared and, in a controlled manner, at any desired time, be initiated by a simple elevation of temperature. For this reason the mixtures can be mixed, for example, outside a reaction vessel and be transferred to a reaction chamber only for the polymerisation itself. Furthermore, on the basis of such an initiator system, a continuous polymerisation can be carried out by continuously adding the reaction mixture to a tube reactor or loop reactor or an extruder or kneader.

Furthermore, the polymerisation can be optimised such that a virtually quantitative conversion of the monomers takes place. This is possible both in solution polymerisation and in a bulk polymerisation. Here the trend was observed that reactions in bulk and in non-polar reaction media lead to comparatively high molecular weights, whereas polar solvents produce polymers with lower molecular weight. A polymerisation is preferred in which at least small amounts of a polar, aprotic solvent such as DMSO (dimethyl sulphoxide), DMF (dimethylformamide) or DMAC (dimethylacetamide) are used. Therefore, the protected N-heterocyclic carbenes may be dissolved initially in such a solvent, before they are added to another solvent or an otherwise pure monomer mixture.

Additionally, the molecular weights of the polymers may be adjusted within a wide spectrum by the method according to the invention. Thus, polymers may be prepared with a weight average molecular weight of between 5000 and 10 000 000 g/mol determined against a polystyrene standard by means of GPC.

### EXAMPLES

### General Polymerisation Procedure

For polymerisation, the monomers, the initiator and optionally solvent, e.g. DMSO, DMF or toluene, were together weighed out in a glove box under argon and transferred to a glass high-pressure vessel or a Schlenk flask. In the case of a solution polymerisation, dried DMSO was used as solvent.

The glass high-pressure vessel or the Schlenk flask was heated in an oil bath, which had been pre-heated to the desired temperature, for the time period of the polymerisation. The reaction was discontinued by dripping the reaction mixture into a methanol precipitation bath. Following centrifugation the supernatant solution was removed and the polymer dried under reduced pressure. The stated yields are the amounts of polymer isolated after drying.

The initial results of a solution polymerisation are shown in Table 1. In this case, the initiator was used in a molar ratio to MMA as monomer of 1 to 280.

TABLE 1

| | | Tem- | | | | | |
|---|---|---|---|---|---|---|---|
| Ex- | | pera- | | | | | |
| am- | Initi- | ture | Time | MMA:DMSO | Yield | Mₙ (PDI) | |
| ple | ator | [° C.] | [h] | [Vol] | [%] | [g/mol] | |
| 1 | (1) | 50 | 91 | 1:0.7 | 12 | n.d. | |
| 2 | (2) | 60 | 72 | 1:0.4 | 75 | 80 000 | (1.82) |
| 3 | (2) | 60 | 69 | 1:0.6 | 72 | 91 000 | (2.0) |
| 4 | (2) | 60 | 45 | 1:0.5 | 95 | 19 000 | (4.0) |
| 5 | (3) | 50 | 19 | 1:1 | 30 | 85 000 | (1.61) |
| 6 | (4) | 50 | 20 | 1:0.4 | 15 | 13 000 | (2.83) |
| 7 | (4) | 75 | 24 | 1:0.4 | 29 | n.d. | |
| 8 | (6) | 85 | 19 | 1:1 | 40 | 12 000 | (1.66) |

| | | | | | | |
|---|---|---|---|---|---|---|
| 9 | (6) | 85 | 20 | 1:0 | 61 | >2 000 000 |
| 10 | (8) | 50 | 21 | 1:0.9 | 18 | n.d. |

In a second experimental series (Table 2) it can be seen that, using N-heterocyclic carbenes (2) or (3), no appreciable conversion takes place at room temperature (see VB1 and VB2), whereas even after less than 20 h at 50° C. or at 60° C., polymerisation could be observed.

TABLE 2

| | | Tem- | | | | |
|---|---|---|---|---|---|---|
| Ex- | | pera- | | | | |
| am- | Initi- | ture | Time | MMA:DMSO | Yield | Mₙ (PDI) |
| ple | ator | [° C.] | [h] | [Vol] | [%] | [g/mol] |
| VB1 | (3) | RT | 23 | 1:1 | <<1 | 40 000 (1.74) |
| 11 | (3) | 50 | 19 | 1:1 | 30 | 85 000 (1.61) |
| 12 | (3) | 60 | 20 | 1:1 | 30 | 48 000 (1.78) |
| VB2 | (2) | RT | 45 | 1:0.2 | <2 | 26 000 (2.60) |
| 13 | (2) | 50 | 43 | 1:0.2 | 14 | 56 000 (1.78) |
| 14 | (2) | 60 | 72 | 1:0.4 | 75 | 80 000 (1.82) |

As already stated, the solution of the protected N-heterocyclic carbene is preferably in a polar, non-reactive solvent. Generally very small amounts of such a solvent, such as for example DMSO, are sufficient (Table 3):

TABLE 3

| | | Tem- | | | | |
|---|---|---|---|---|---|---|
| Ex- | | pera- | | | | |
| am- | Initi- | ture | Time | MMA:DMSO | Yield | Mₙ (PDI) |
| ple | ator | [° C.] | [h] | [Vol] | [%] | [g/mol] |
| 15 | 5-tBu—CO₂ | 60 | 18 | 1:0.3 | 32 | 23 000 (1.64) |
| 16 | 5-tBu—CO₂ | 85 | 18 | 1:0.3 | 39 | 13 000 (1.66) |
| 17 | 5-tBu—CO₂ | 85 | 18 | 1:0.2 | 35 | 18 000 (1.70) |
| 18a | 5-tBu—CO₂ | 85 | 18 | 1:1 | 45 | 12 000 (1.67) |
| 18b | 5-tBu—CO₂ | 85 | 68 | 1:1 | 44 | 14 000 (1.61) |

Very good results could be achieved with the initiator (6) (Table 4). These results could be achieved both in bulk and in non-polar solvents such as toluene or dimethoxyethane (DME). On the basis of the good solubility of compound (6), no addition of DMSO was carried out. It was also established here that without solvent or with polar solvents distinctly higher molecular weights can be achieved. Examples 26 to 28 show correspondingly low molecular weights in a polar solvent such as DMF (dimethylformamide). The latter also occur with very high conversions. The comparative experiment VB3, in contrast, did not result in any conversion. Evidently, a “true” latency is present here. The polymerisation described does not proceed at RT when using the carboxylate in place of the free carbene, i.e. the latency depends on a blocking of the active species which can be thermally activated, and not on a very slow reaction at RT.

TABLE 4

| | | Tem- | | | | | |
|---|---|---|---|---|---|---|---|
| Ex- | | pera- | | | | | |
| am- | Initi- | ture | Time | MMA:Solv. | Yield | Mₙ (PDI) | |
| ple | ator | [° C.] | [h] | [Vol] | [%] | [g/mol] | |
| 19 | (6) | 85 | 20 | No solvent | 61 | approx. 2 000 000 | |
| 20 | (6) | 85 | 21 | Toluene, 1:1 | 56 | 420 000 | (1.33) |
| 21 | (6) | 85 | 68 | Toluene, 1:2 | 64 | 350 000 | (1.46) |
| 22 | (6) | 85 | 69 | Toluene, 1:3 | 68 | 240 000 | (1.60) |
| 23a | (6) | 85 | 43 | Toluene, 1:4 | 70 | 210 000 | (1.64) |
| 23b | (6) | 85 | 71 | Toluene, 1:4 | 91 | 150 000 | (1.85) |
| 24 | (6) | 85 | 22 | DME, 1:1 | 32 | 490 000 | (1.25) |
| 25 | (6) | 85 | 24 | DME, 1:4 | 29 | 200 000 | (1.84) |
| 26b | (6) | 85 | 20 | DMF, 1:0.5 | 96 | 12 000 | (2.7) |
| 26a | (6) | 85 | 4 | DMF, 1:0.5 | 78 | 10 000 | (2.6) |
| 27 | (6) | 100 | 3.5 | DMF, 1:0.5 | 46 | 8000 | (2.7) |
| 28 | (6) | 85 | 21 | DMF, 1:4 | 49 | 25 000 | (2.7) |

| | | | | | | |
|---|---|---|---|---|---|---|
| VB3 | (6) | RT | 48 | DMF, 1:4 | 0 | — |

The initiators (12), (13) and (14) are all soluble in MMA without addition of polar solvent. In particular (13) is found to be active: high yields are possible in short reaction times of 5 h, and molar masses around 20 000 g/mol are achieved. Rapid polymerisation occurs, particularly with addition of DMSO, whereas polymerisations without solvent proceed more slowly (see table 5). An optimum temperature appears to be around 70° C. An increase in the proportion of solvent gives rise to somewhat lower yields for the same polymerisation time, but higher molecular weight.

TABLE 5

| | | Tem- | | | | |
|---|---|---|---|---|---|---|
| Ex- | | pera- | | | | |
| am- | Initi- | ture | Time | MMA:DMSO | Yield | Mₙ (PDI) |
| ple | ator | [° C.] | [h] | [Vol] | [%] | [g/mol] |
| VB4 | (12) | RT | 21 | 1:0.5 | 1 | — |
| 29 | (12) | 50 | 5 | 1:0.5 | 28 | 18 000 (4.2) |
| 30 | (12) | 70 | 5 | 1:0.5 | 78 | 28 000 (3.2) |
| 31 | (12) | 85 | 5 | 1:0.5 | 73 | 18 000 (3.5) |
| 32 | (12) | 85 | 5 | 1:2 | 51 | 28 000 (3.2) |
| 33 | (12) | 85 | 72 | Bulk | 85 | 18 000 (4.4) |
| | | | | polymerisation | | |
| 34 | (12) | 70 | 16 | 1:0.1 | 93 | 17 000 (4.0) |
| 35 | (13) | 85 | 20 | 1:0.5 | 37 | 11 000 (3.2) |
| 36 | (14) | 85 | 25 | 1:0.5 | 22 | 12 000 (2.1) |

1. A method for initiating a polymerisation of vinyl monomers, the method comprising:
treating a monomer mixture or a monomer solution of the vinyl monomers with a protected N-heterocyclic carbine, and
initiating the polymerisation by raising temperature to an initiation temperature of at least 40° C., thereby obtaining a polymer,
wherein the vinyl monomers are acrylates, methacrylates, styrene, monomers derived from styrene, or any mixture thereof.

2. (canceled)

3. The method according to claim 1, wherein the protected N-heterocyclic carbene is a compound of formula (I) or formula (II), 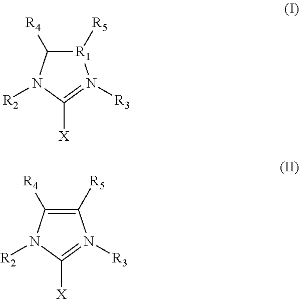
where
R₁ is a CH₂, C₂H₄, C₃H₆ or a corresponding substituted residue,
R₂ and R₃ are each independently a cyclic, branched or linear, optionally heteroatom-containing alkyl residue having from 1 to 20 carbon atoms or a substituted or non-substituted aromatic residue,
R₄ and R₅ are each independently hydrogen, or a cyclic, branched or linear, optionally heteroatom-containing alkyl residue having from 1 to 20 carbon atoms or a substituted or non-substituted aromatic residue, and
X is CO₂, CS₂, Zn, Bi, Sn or Mg.

4. The according to claim 1, wherein the protected N-heterocyclic carbene is a compound of formula (III) or formula (IV), 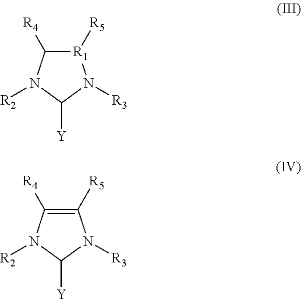
where
R₁ is a CH₂, C₂H₄, C₃H₆ or a corresponding substituted residue,
R₂ and R₃ are each independently a cyclic, branched or linear, optionally heteroatom-containing alkyl residue having from 1 to 20 carbon atoms or a substituted or non-substituted aromatic residue,
R₄ and R₅ are each independently hydrogen, or a cyclic, branched or linear, optionally heteroatom-containing alkyl residue having from 1 to 20 carbon atoms or a substituted or non-substituted aromatic residue, and
Y is a CF₃, C₆F₄, C₆F₅, CCl₃ or OR₄ residue, where R₄ is an alkyl residue having from 1 to 10 carbon atoms.

5. The method according to claim 1, wherein the polymer, measured by GPC compared to a polystyrene standard, has a weight average molecular weight of from 5000 to 10 000 000 g/mol.

6. The method according to claim 1, wherein the initiation temperature is between 50° C. and 100° C.

7. The method according to claim 3, wherein the polymer, measured by GPC compared to a polystyrene standard, has a weight average molecular weight of from 5000 to 10 000 000 g/mol.

8. The method according to claim 4, wherein the polymer, measured by GPC compared to a polystyrene standard, has a weight average molecular weight of from 5000 to 10 000 000 g/mol.

9. The method according to claim 3, wherein the initiation temperature is between 50° C. and 100° C.

10. The method according to claim 4, wherein the initiation temperature is between 50° C. and 100° C.

11. The method according to claim 5, wherein the initiation temperature is between 50° C. and 100° C.
